(19) United States
(12) Patent Application Publication
(10) Pub. No.: US 2025/0334528 A1
(43) Pub. Date: Oct. 30, 2025

(54) X-RAY APPARATUS FOR ANALYZING THREE-DIMENSIONAL NANOSTRUCTURES AND METHOD FOR ANALYZING THREE-DIMENSIONAL NANOSTRUCTURES

(71) Applicant: INDUSTRIAL TECHNOLOGY RESEARCH INSTITUTE, Hsinchu (TW)

(72) Inventors: Chun-Yu LIU, Taipei City (TW); Wei-En FU, Taoyuan City (TW); Wen-Li WU, Hsinchu City (TW)

(73) Assignee: INDUSTRIAL TECHNOLOGY RESEARCH INSTITUTE, Hsinchu (TW)

(21) Appl. No.: 18/647,476

(22) Filed: Apr. 26, 2024

(51) Int. Cl. G01N 23/203; G01N 23/207

(52) U.S. Cl. CPC G01N 23/203; G01N 23/2076; G01N 2223/1016

(57) ABSTRACT

An X-ray apparatus for analyzing three-dimensional nanostructures and a method for analyzing three-dimensional nanostructures are provided. The X-ray apparatus for analyzing three-dimensional nanostructures includes an X-ray source for emitting X-ray, an X-ray reflection device configured to reflect the X-ray onto a sample surface of a sample, and an X-ray detector configured to collect reflected X-ray reflected by the sample surface of the sample. The X-ray has a wavelength greater than or equal to 0.154 nm. The reflected X-ray includes a plurality of scattered X-rays. The X-ray detector collects a plurality of scattered intensities and a plurality of scattering angles of the plurality of scattered X-ray and analyzes structural information of the sample based on at least one of the plurality of scattered intensities and the plurality of scattering angles.

### TECHNICAL FIELD

The disclosure relates to an analyzing apparatus, and more relates to an X-ray apparatus for analyzing three-dimensional nanostructures and a method for analyzing three-dimensional nanostructures.

### BACKGROUND

X-ray reflectometry (XRR) uses X-ray to analyze single layer nanostructures and multilayer nanostructures, and can obtain various parameters of structures through detecting the intensity of X-ray reflected by the sample. The parameters of structures includes roughness, diffusion of the interface layer, critical dimension (CD), thickness of single layer nanostructures and multilayer nanostructures, etc. However, with the technological development, the size of nanostructures has shrunk and the nanostructures have become more complex, it has become increasingly difficult to analyze various parameters of nanostructures by existing X-ray reflection technology.

Therefore, there is a need to provide an improved X-ray apparatus for analyzing three-dimensional nanostructures and method for analyzing three-dimensional nanostructures.

### SUMMARY

The disclosure is directed to an X-ray apparatus for analyzing three-dimensional nanostructures and a method for analyzing three-dimensional nanostructures, which uses X-ray having a wavelength greater than or equal to 0.154 nm and collects scattered X-ray reflected by the sample to obtain parameters of three-dimensional nanostructures and can be applied on small nanostructures.

According to one embodiment, an X-ray apparatus for analyzing three-dimensional nanostructures is provided. The X-ray apparatus for analyzing three-dimensional nanostructures includes an X-ray source for emitting X-ray, an X-ray reflection device configured to reflect the X-ray onto a sample surface of a sample, and an X-ray detector. The X-ray has a wavelength greater than or equal to 0.154 nm. The X-ray detector is configured to collect reflected X-ray reflected by the sample surface of the sample. The reflected X-ray includes a plurality of scattered X-rays. The X-ray detector collects a plurality of scattered intensities and a plurality of scattering angles of the plurality of scattered X-ray and analyzes structural information of the sample based on at least one of the plurality of scattered intensities and the plurality of scattering angles.

According to another embodiment, a method for analyzing three-dimensional nanostructures is provided. The method includes: emitting X-ray by an X-ray source; reflecting the X-ray onto a sample surface of a sample by an X-ray reflection device; collecting reflected X-ray reflected by the sample surface of the sample by an X-ray detector, wherein the reflected X-ray comprises a plurality of scattered X-rays; analyzing structural information of the sample based on at least one of a plurality of scattered intensities and a plurality of scattering angles of the plurality of scattered X-ray.

The above and other embodiments of the disclosure will become better understood with regard to the following detailed description of the non-limiting embodiment(s). The following description is made with reference to the accompanying drawings.

### BRIEF DESCRIPTION OF THE DRAWINGS

FIG. 1 illustrates a schematic view of an X-ray apparatus and a method for analyzing three-dimensional nanostructures according to an embodiment of the present disclosure.

FIG. 2A illustrates a schematic view of reflected X-ray reflected by the sample according to an embodiment of the present disclosure.

FIG. 2B illustrates a schematic view of reflected X-ray reflected by the sample according to an embodiment of the present disclosure.

FIG. 3 shows an intensity distribution diagram of scattered signals according to an embodiment of the present disclosure.

### DETAILED DESCRIPTION

Various embodiments of X-ray apparatuses and methods for analyzing three-dimensional nanostructures are provided below. The drawings may be simplified to provide an understanding of various embodiments of the present disclosure, and the components in the drawings may not be drawn to scale. The specification and drawings are provided for illustrative and explaining purposes rather than a limiting purpose. The same/similar reference numerals are used to represent the same/similar components in the description below and the drawings. Directional terms such as X direction, Y direction and Z direction which may be perpendicular to each other are used in the following embodiments to indicate the directions of the accompanying drawings, not for limiting the present disclosure.

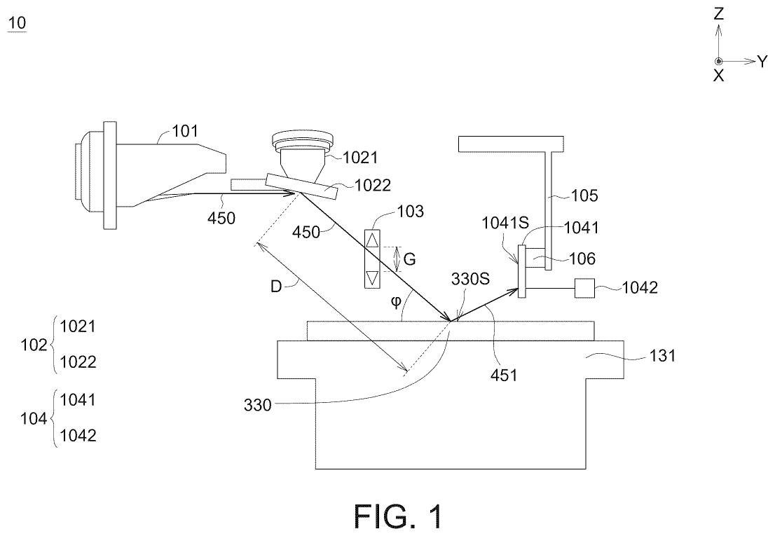

Referring to FIG. 1, FIG. 1 illustrates a schematic view of an X-ray apparatus 10 and a method for analyzing three-dimensional nanostructures according to an embodiment of the present disclosure. The X-ray apparatus 10 include an X-ray source 101, an X-ray reflection device 102, an incident slit 103, an X-ray detector 104, a multi-axis moving device 105 and a rotating device 106.

The X-ray source 101 is configured for emitting X-ray 450. The X-ray 450 has a wavelength greater than or equal to 0.154 nm. The X-ray source 101 can include metal as a target material. Electrons accelerated by high voltage collide with the metal target to generate X-ray 450. The metal target may include a copper target, an aluminum target, a cobalt target, an iron target, a chromium target and an alloy target including the above metals. In an embodiment, the X-ray 450 generated by a copper target has a wavelength of 0.154 nm. In an embodiment, the X-ray 450 generated by an aluminum target has a wavelength of 0.834 nm. In an embodiment, the X-ray 450 generated by a cobalt target has a wavelength of 0.179 nm. In an embodiment, the X-ray 450 generated by an iron target has a wavelength of 0.194 nm. In an embodiment, the X-ray 450 generated by a chromium target has a wavelength of 0.229 nm. The metal targets that can be used in the present disclosure are not limited to the above examples. Any target that can generate X-ray with a wavelength greater than or equal to 0.154 nm can be used in the present disclosure.

The X-ray reflection device 102 is configured to reflect the X-ray 450 from the X-ray source 101 onto a sample surface 330S of a sample 330. The incident angle φ of the X-ray 450 with respect to the sample surface 330S and the footprint size of the X-ray 450 on the sample surface 330S can be controlled by controlling the focus distance D of the X-ray reflection device 102. The X-ray reflection device 102 may include a six-axis controller 1021 and a reflector 1022. The six-axis controller 1021 can be used to control the reflector 1022, such as rotate or move the reflector 1022, to focus the X-ray 450 on the sample surface 330S. The reflector 1022 can be mirrors or an X-ray monochromator. The mirrors may include, but are not limited to, X-ray collimators, refractive X-ray optical elements, diffractive optical elements, Schwarzschild optical elements, Kirkpatrick-Baez optical elements, Montel optical elements, Wolter optical elements, specular X-ray optical elements, and the like. Mirrors can be served as ellipsoidal mirrors, polycapillary optics, multilayer optics or systems. In an embodiment, the X-ray reflection device 102 may include two or more mirrors. The Rowland circle of the X-ray monochromator may have a diameter greater than or equal to 500 mm. The incident slit 103 is disposed between the X-ray reflection device 102 and the sample 330. The incident slit 103 is disposed on the traveling path of the X-ray 450. The X-ray 450 from the X-ray source 101 passes through the incident slit 103 to the sample surface 330S after the X-ray 450 from the X-ray source 101 is reflected by the reflector 1022 of the X-ray reflection device 102. The incident slit 103 can be used to adjust the divergence and/or the spatial characteristics of the X-ray 450. For example, the divergence of the X-ray 450 (e.g. divergence angle) can be changed by changing the slit width G of the incidence slit 103. For example, the spatial characteristics of the X-ray 450 (e.g. position, beam size or beam shape on the sample surface 330S) can be controlled by controlling the position of the incident slit 103. The incident slit 103 can be an aperture optical element or a slit element controlled by uniaxial piezoelectricity. In the present embodiment, the sample surface 330S is on the plane formed by the X direction and the Y direction. The divergence angle may be the function of the incident angle φ. Different incident angles cp can correspond to different divergence angles.

In the present embodiment, the X-ray 450 can approach and be focused on the sample surface 330S, the focus area of the X-ray 450 can be less than or equal to 0.02 mm², and the footprint size of the X-ray 450 on the sample surface 330S can be less than or equal to 1.2 mm². The incident angle φ of the X-ray 450 is adjustable within a predetermined range of angle (e.g. in the range of 1° to 45°). The focus distance D of the X-ray reflection device 102 can be greater than or equal to 150 mm. In an embodiment, the wavelength of the X-ray 450 is less than or equal to 2 times the feature size of sample 330 in the Z direction. The feature size of sample 330 in the Z direction can be selected from the group consisting of layer thicknesses of the surface and feature height of a nanostructure.

The sample 330 can be placed on the platform 131. The sample surface 330S of the sample 330 can include nanostructures, and nanostructure mean that the structure has at least one dimension on the nanoscale. The sample surface 330S may include one-dimensional or two-dimensional periodically arranged nanostructures. For example, the sample 330 can be a semiconductor wafer. For example, the sample 330 can include a fin field-effect transistor (FET), a gate-all-around (GAA) transistor, a fork-sheet transistor, a capacitor, and the like. In an embodiment, the platform 131 is rotatable so as to rotate the sample 330 around the Z direction.

The X-ray detector 104 is configured to collect reflected X-ray 451 reflected by the sample surface 330S. The term “reflected by the sample surface 330S” used herein include reflection or scattering on the sample surface 330S and reflection or scattering in the range of several nanometers to several micrometers below the sample surface 330S. The X-ray detector 104 includes an X-ray sensor 1041 and an analyzer 1042. The X-ray sensor 1041 is configured to collect the reflected X-ray 451 reflected by the sample surface 330S. In an embodiment, the reflected X-ray 451 reflected by the sample surface 330S forms a scattered image projected on sensor surface 1041S of the X-ray sensor 1041. The X-ray sensor 1041 has a size that can completely collect the reflected X-ray 451 reflected by the sample surface 330S. The analyzer 1042 connects the X-ray sensor 1041. The analyzer 1042 is configured to collect the reflected X-ray intensity of the reflected X-ray 451 while the X-ray sensor 1041 collects the reflected X-ray 451. In other embodiment, the analyzer 1042 is configured to collect the X-ray photoelectron spectroscopy (XPS) signals and/or X-ray fluorescence spectrometer (XRF) signals while the X-ray sensor 1041 collects the reflected X-ray 451. In an embodiment, the X-ray sensor 1041 is arranged in a vacuum chamber, and the analyzer 1042 is arranged outside the vacuum chamber. The multi-axis moving device 105 is configured to control the X-ray sensor 1041 to move along at least one of an X direction, a Y direction and a Z direction, such that the X-ray sensor 1041 can collect the reflected X-ray 451. The rotating device 106 is coupled between the X-ray sensor 1041 and the multi-axis moving device 105. The rotating device 106 is configured to rotate the X-ray sensor 1041 in the X direction and the Z direction. In an embodiment, the X-ray apparatus 10 may not include the multi-axis moving device 105 and/or the rotating device 106. The resolution of signals collected by the X-ray detector 104 can be controlled by controlling the distance between the sample 330 and the X-ray detector 104.

The X-ray 450 may be fan-shaped X-ray or cone-shape X-ray. The reflected X-ray 451 may have a plurality of azimuthal angles. By fan-shaped or cone-shaped focusing, the light intensity can be effectively increased, the detection area can be reduced, and the signals along different directions can be received.

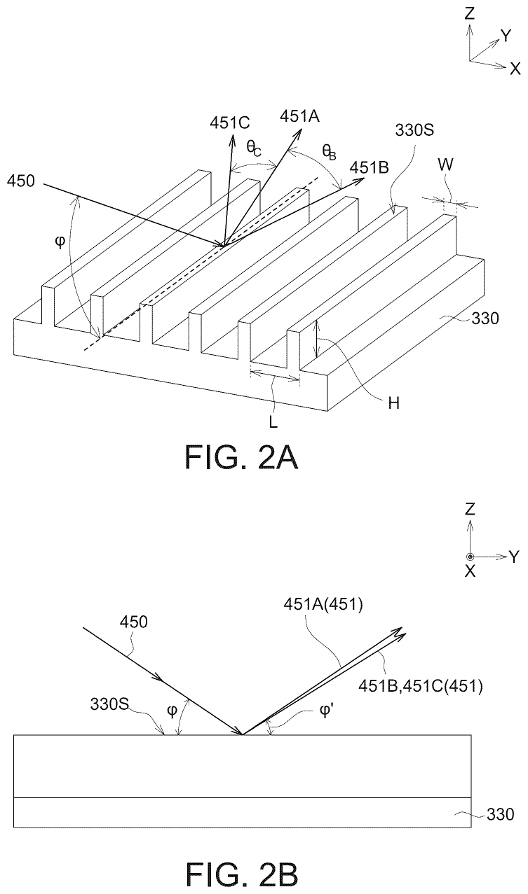

Referring to FIGS. 1, 2A and 2B, FIGS. 2A and 2B illustrate schematic views of reflected X-ray 451 reflected by the sample 330 at different viewing angles. The X-ray 450 approach the sample surface 330 with the incident angle φ. The periodically arranged nanostructures of the sample 330 can be arranged along the X direction.

The reflected X-ray 451 reflected by the sample surface 330S includes X-rays corresponding to different scattering orders, and the scattering orders may include . . . −4^{th}, −3^{rd}, −2^{nd}, −1^{st}, 0^{th}, +1^{st}, +2^{nd}, +3^{rd}, +4^{th} . . . scattering orders. In the present embodiment, the reflected X-ray 451 includes specularly reflected X-ray 451A corresponding to 0^{th} scattering order, and a plurality of scattered X-rays 451B and 451C corresponding to non-zero scattering orders. The scattered X-rays 451B and 451C represent X-rays non-specularly reflected by the sample surface 330S. The scattered X-rays 451B and 451C can be understood as non-specularly reflected X-ray. The specularly reflected X-ray 451A has an exit angle (or reflection angle) φ′ with respect to the sample surface 330S, and the exit angle φ′ is equal to the incident angle φ of the X-ray 450 with respect to the sample surface 330S. The scattered X-ray 451B may correspond to the +1^{st} scattering order. The angle between the scattered X-ray 451B and the specularly reflected X-ray 451A can be defined as a scattering angle θ_{B} of the scattered X-ray 451B. The scattered X-ray 451C may correspond to the −1^{st} scattering order. The angle between the scattered X-ray 451C and the specularly reflected X-ray 451A can be defined as a scattering angle θ_{C} of the scattered X-ray 451C. The scattered X-rays with different scattering orders may have different scattering angles θ. FIGS. 2A and 2B shows scattered X-rays corresponding to two scattering orders (scattered X-rays 451B and 451C), but the present disclosure is not limited thereto, the reflected X-ray may include scattered X-rays corresponding to more or less scattering orders. The angle of the specularly reflected X-ray 451A with respect to the sample surface 330S (i.e. exit angle φ′) is similar to the angles of the scattered X-rays 451B and 451C with respect to the sample surface 330S, and thus from the perspective of FIG. 2B, the specularly reflected X-ray 451A, the scattered X-ray 451B, and the scattered X-ray 451C approximately overlap.

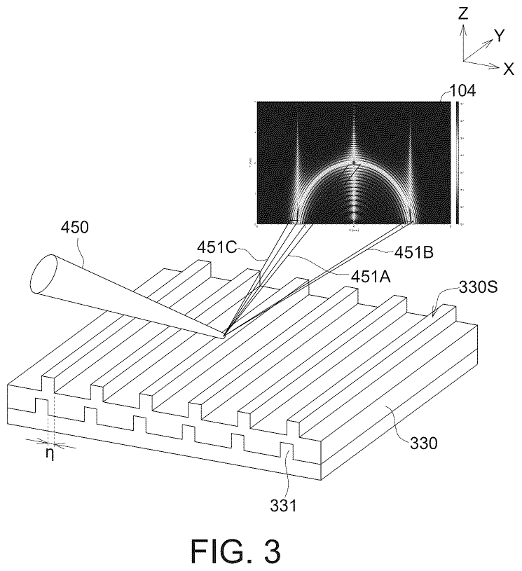

In some embodiments, the X-ray sensor 1041 is a two-dimensional X-ray sensor for collecting the specularly reflected X-ray and a plurality of the scattered X-rays at the same time. In some embodiments, the analyzer 1042 of the X-ray detector 104 can record information such as positions, intensities, and scattering angles of a plurality of the scattered X-rays corresponding to different scattering orders to analyze the structural information of the sample 330. The X-ray detector 104 can generate an intensity distribution diagram of scattered signals based on the collected signals, as shown in FIG. 3.

The X-ray apparatus 10 shown in FIG. 1 can be used to perform a method for analyzing three-dimensional nanostructures. The method may include the following steps.

Emitting X-ray 450 by the X-ray source 101. Reflecting the X-ray 450 onto the sample surface 330S of the sample 330 placed on the platform 131 by the X-ray reflection device 102. Collecting the reflected X-ray 451 reflected by the sample surface 330S of the sample 330 by the X-ray sensor 1041 of the X-ray detector 104. The analyzer 1042 of the X-ray detector 104 can collect reflected X-ray intensity of the reflected X-ray 451. In an embodiment, the analyzer 1042 obtains intensity of the specularly reflected X-ray of the reflected X-ray 451, removes background signals and the intensity of the specularly reflected X-ray from the reflected X-ray intensity, and the non-specular reflection (scattering) value components of the remaining reflected X-ray intensity corresponding to each azimuthal angle can be integrated to obtain the scattered intensity of each scattered X-ray. The reflected X-ray 451 includes a plurality of scattered X-rays, and thus the analyzer 1042 can obtain a plurality of scattered intensities corresponding to incident angles, scattering orders and scattering angles. The analyzer 1042 analyzes structural information of the sample 330 based on at least one of a plurality of scattered intensities and a plurality of scattering angles of the plurality of scattered X-ray.

For example, the method for analyzing three-dimensional nanostructures can obtain the pitch of the sample 330 through the following formula (1) based on the wavelength, scattering order and scattering angle of X-ray. In formula (1), X is the wavelength of X-ray, n is the scattering order, θₙ is the scattering angle corresponding to this scattering order, and L is the pitch. Take FIG. 2A as an example, the scattered X-ray 451B corresponds to the +1^{st} scattering order (n=1), and the pitch of the sample 330 can be obtained through the formula (1) based on the wavelength of X-ray, the scattering order of the scattered X-ray 451B (n=1) and the scattering angle of the scattered X-ray 451B.

$$sin {θ}_{n} = \frac{n λ}{L} \qquad ( 1 )$$

The method for analyzing three-dimensional nanostructures may further include controlling the divergence and/or spatial characteristics of the X-ray 450 through the incident slit 103. The method for analyzing three-dimensional nanostructures may further include controlling the X-ray sensor 1041 of the X-ray detector 104 to move along at least one of the X direction, the Y direction and the Z direction through the multi-axis moving device 105 to collect the reflected X-ray 451. The method for analyzing three-dimensional nanostructures may further include rotating the X-ray sensor 1041 of the X-ray detector 104 in the X direction and the Z direction through the rotating device 106 to collect the reflected X-ray 451.

The method for analyzing three-dimensional nanostructures can be used to analyze structural information of the sample, the structural information includes line width W (as shown in FIG. 2A), pitch L (as shown in FIG. 2A), feature height H (as shown in FIG. 2A), critical dimension, shape, overlay error η (as shown in FIG. 3), layer thickness, sidewall angle, and the like. The overlay error represents the alignment accuracy between the nanostructures in different layers of the sample. Taking FIG. 3 as an example, the overlay error η can represent the alignment accuracy between the nanostructure of the sample surface 330S and the nanostructure of the underlying layer.

The X-ray apparatus and method of the present disclosure can select the incident angle φ of the X-ray 450 according to the size of the nanostructure to be measured. A larger incident angle φ can correspond to a smaller projection area, so it can be applied to a smaller measurement area. In the comparative example of using X-ray having a short wavelength (wavelength less than 0.154 nm) to analyze a sample, the use of a large incident angle φ (e.g., greater than or equal to 5 degrees) can reduce the projection area of X-ray, but will result in weak reflection signals. Weak reflection signals are difficult to detect, and thus the comparative example cannot complete the analysis of the sample. The present disclosure uses X-ray having a long wavelength (wavelength greater than or equal 0.154 nm) to analyze a sample, a small projection area and clear reflection signals can be obtain with the use of a larger incident angle φ, which can be applied to analyze a smaller measurement area. When the present disclosure uses the long-wavelength X-ray with a small incident angle φ (e.g., less than 5 degrees, which can also be understood as a grazing incidence angle), clear reflection signals and a projection area of X-ray can be obtained, which can be applied to analyze a large measurement area. That is to say, the X-ray apparatus and method of the present disclosure can be applied to analyze measurement areas of various sizes.

In the comparative example of using X-ray having a short wavelength (wavelength less than 0.154 nm) to analyze a sample, reflected X-ray generated by the reflection of short-wavelength X-ray by the sample are tightly distributed in space, scattered X-rays with low scattering orders are easily covered by direct light, resulting in the inability to detect scattered X-rays with low scattering orders or causing the inability to individually identify scattered X-rays with low scattering orders, and therefore it is difficult to obtain structural information related to scattered X-rays with low scattering order. The present disclosure uses X-ray having a long wavelength (wavelength greater than or equal 0.154 nm) to analyze a sample, under the same scattering conditions, long-wavelength X-ray have larger scattering angles at each scattering order, so that the scattered X-rays at each scattering order can be spatially separated and the related structural information can be obtained.

In order to effectively detect the reflected X-rays reflected by the sample, the distance between the X-ray detector and the sample is usually maintained greater than or equal to a minimum detection distance. The long-wavelength X-ray (wavelength greater than or equal 0.154 nm) used in the present disclosure has larger scattering angles, so that the minimum detection distance between the detector and the sample can be smaller than that of the comparative example. In other words, the X-ray detector in the X-ray apparatus and method of the present disclosure can be arranged closer to the sample than in the comparative example, which can effectively reduce the size of the X-ray apparatus.

While the present disclosure has been described in terms of the above embodiments, it is to be understood that the present disclosure is not limited thereto. Modifications and variations can be made by a person having ordinary skill in the art without departing from the spirit of the disclosure. Therefore, the scope of the present disclosure is defined by the appended claims.

What is claimed is:

1. An X-ray apparatus for analyzing three-dimensional nanostructures, comprising:
an X-ray source for emitting X-ray, wherein the X-ray has a wavelength greater than or equal to 0.154 nm;
an X-ray reflection device configured to reflect the X-ray onto a sample surface of a sample; and
an X-ray detector configured to collect reflected X-ray reflected by the sample surface of the sample,
wherein the reflected X-ray comprises a plurality of scattered X-rays, the X-ray detector collects a plurality of scattered intensities and a plurality of scattering angles of the plurality of scattered X-ray and analyzes structural information of the sample based on at least one of the plurality of scattered intensities and the plurality of scattering angles.

2. The method according to claim 1, wherein the X-ray has a wavelength greater than 0.154 nm.

3. The method according to claim 1, further comprising:
a multi-axis moving device configured to control the X-ray detector to move along at least one of an X direction, a Y direction and a Z direction.

4. The method according to claim 1, further comprising:
an incident slit disposed between the X-ray reflection device and the sample, wherein the X-ray from the X-ray source passes through the incident slit to the sample surface of the sample after the X-ray from the X-ray source is reflected by the X-ray reflection device.

5. The method according to claim 1, wherein the reflected X-ray comprises specularly reflected X-ray, and the X-ray detector collects reflected X-ray intensity of the reflected X-ray and removes intensity of the specularly reflected X-ray from the reflected X-ray intensity.

6. A method for analyzing three-dimensional nanostructures, comprising:
emitting X-ray by an X-ray source;
reflecting the X-ray onto a sample surface of a sample by an X-ray reflection device;
collecting reflected X-ray reflected by the sample surface of the sample by an X-ray detector, wherein the reflected X-ray comprises a plurality of scattered X-rays; and
analyzing structural information of the sample based on at least one of a plurality of scattered intensities and a plurality of scattering angles of the plurality of scattered X-ray.

7. The method according to claim 6, wherein the reflected X-ray comprises specularly reflected X-ray, and method further comprises:
collecting reflected X-ray intensity of the reflected X-ray by the X-ray detector;
collecting intensity of the specularly reflected X-ray by the X-ray detector; and
removing the intensity of the specularly reflected X-ray from the reflected X-ray intensity of the reflected X-ray.

8. The method according to claim 6, wherein the X-ray has a wavelength greater than or equal to 0.154 nm.

9. The method according to claim 6, wherein the plurality of scattered X-ray correspond to the plurality of scattering angles, and the plurality of scattering angles are different from each other.
